(19) United States
(12) Patent Application Publication
(10) Pub. No.: US 2011/0010942 A1
(43) Pub. Date: Jan. 20, 2011

(54) NOSE HAIR TRIMMER, NOSE HAIR TRIMMER ARRANGEMENT, NOSE HAIR TRIMMER ATTACHMENT, TRIMMER BLADE ARRANGEMENT AND MANUFACTURING METHODS THEREFOR

(75) Inventor: Tung Yan LAU, New Territories (HK)

Correspondence Address: OSTROLENK FABER GERB & SOFFEN, 1180 AVENUE OF THE AMERICAS, NEW YORK, NY, 100368403, US

(73) Assignee: Specialife Industries Limited

(21) Appl. No.: 12/725,761

(22) Filed: Mar. 17, 2010

Related U.S. Application Data
(63) Continuation of application No. 12/505,551, filed on Jul. 20, 2009.

(51) Int. Cl. B26B 19/06; B26B 19/38

(52) U.S. Cl. 30/29.5; 30/216; 30/223; 29/592

(57) ABSTRACT

A nose hair trimmer with dual cutting edges which comprises a stationary blade with a plurality of teeth disposed on two opposite longitudinal sides thereof; a movable blade with a plurality of teeth disposed on two opposite longitudinal sides thereof, and the movable blade is driven by a driving unit to move in a linear reciprocating manner against the stationary blade so that the teeth on one side of the stationary blade and the teeth on one side of the movable blade cooperate with each other to define a first cutting edge, and the teeth on the other side of the stationary blade and the teeth on the other side of the movable blade cooperate with each other to define a second cutting edge; and a casing having a head portion in shape and size adapted to be inserted into a human nose, and the head portion is provided with two longitudinal openings disposed opposite to each other for exposing the first cutting edge and the second cutting edge respectively, so that the first cutting edge and the second cutting edge are positioned substantially parallel to a longitudinal axis of a nasal passage of a human nose when the head portion is inserted into the nose.

### CROSS REFERENCE TO RELATED APPLICATION

This application is a continuation of U.S. patent application Ser. No. 12/505,551, filed Jul. 20, 2009, in the name of Tung Yan LAU et al. and entitled NOSE HAIR TRIMMER WITH DUAL CUTTING EDGES.

### FIELD OF THE INVENTION

The present invention relates to a nose hair trimmer. More particularly, but not exclusively, it relates to a nose hair trimmer with dual cutting edges.

The present invention further relates to a trimmer blade for a hair trimmer, and manufacturing methods therefor.

### BACKGROUND OF THE INVENTION

There are two types of nose hair trimmers commonly available in the marketplace, namely rotary nose hair trimmers and linear nose hair trimmers. A rotary nose hair trimmer uses a set of small rotary blades protected by a stainless steel housing disposed at the head portion of the casing for trimming nose hair. The stainless steel housing prevents the blades from coming into direct contact with the nasal passage of a human nose and thereby making the nose hair trimmer safer to use. A linear nose hair trimmer has a movable teethed blade and a fixed teethed blade disposed at an upper end of a longitudinally shaped casing for insertion into a human nose. The teeth of the movable blade and the stationary blade cooperate with each other to define a cutting zone which is substantially perpendicular to a longitudinal axis of the nasal passage of a human nose. Both the aforementioned types are relatively inefficient in cutting nose hair as the area of the cutting edge is relatively small and ungainly to manipulate to a cutting position.

Trimmers produced currently utilise a known blade arrangement. This blade arrangement includes two planar blades disposed to abut each other along at least part of each of their major faces. Each blade has teeth along at least one toothed edge. The toothed edges of each of the blades is disposed adjacent each other. When the blades move relative to each other, the toothed edges create a scissoring action which is capable of pinching a hair follicle between the relatively moving toothed edges to sever it.

The length of the trimmed hair depends on the thickness of the blades. The length of the trimmed hair determines the closeness and the smoothness of the trimming action. It would be desirable to be able to reduce the length of the trimmed hair, to thereby increase the smoothness of the trim. This may require additional machining of at least one of the blades.

However, in the context of mass production, such fine individual machining of one or more of the blades may not always be cost effective. It would be desirable to mass produce such blades with relatively high accuracies and reduced cost.

For the purposes of this specification, where a series of steps are described in a method, it shall be understood that the steps may not necessarily be in chronological order.

### OBJECT OF THE INVENTION

In view of the aforesaid disadvantages now present in the prior art, an object of the present invention is to provide a nose hair trimmer which has a larger area of cutting edges and therefore could reduce the time and effort for trimming nose hair.

It is an alternate object of the present invention to provide a nose hair trimmer which is safe to operate and prevents the nasal passage of a human nose from being injured during nose hair trimming.

An alternate object of the present invention is to provide a nose hair trimmer which is simple in its structure and overall assembly complexity.

An alternate object of the present invention is to provide a nose hair trimmer which is susceptible of a low cost of manufacture with regard to both materials and labor, and which accordingly is then susceptible of low prices of sale to the consuming public, thereby making such nose hair trimmers economically available to the buying public.

An alternate object of the present invention is to provide a nose hair trimmer which overcomes or at least partially ameliorates some of the abovementioned disadvantages or which at least provides the public with a useful choice.

It is an alternate object of the present invention to provide a trimmer blade arrangement and method therefor which overcomes or at least partially ameliorates some of the abovementioned disadvantages or which at least provides the public with a useful choice.

### SUMMARY OF THE INVENTION

The present invention generally comprises a stationary blade, a movable blade and a casing. The stationary blade has a plurality of teeth disposed on two opposite longitudinal sides thereof. The movable blade has a plurality of teeth disposed on two opposite longitudinal sides thereof. The movable blade is driven by a driving unit to move in a linear reciprocating manner against the stationary blade so that the teeth on one of the longitudinal sides of the stationary blade and the teeth on one of the longitudinal sides of the movable blade cooperate with each other to define a first cutting edge, and the teeth on the other longitudinal side of the stationary blade and the teeth on the other longitudinal side of the movable blade cooperate with each other to define a second cutting edge. The casing has a head portion in shape and size adapted to be inserted up a human nostril. The head portion is provided with two longitudinal openings disposed opposite to each other for exposing the first cutting edge and the second cutting edge respectively, so that the first cutting edge and the second cutting edge are positioned substantially parallel to a longitudinal axis of a nasal passage of a human nose when the head portion is inserted into the nose.

In a preferred embodiment, the two longitudinal openings are provided on two opposite sides at a lower part of the head portion, and an upper part of the head portion is used for housing a driving arm of the driving unit which is securely connected to the movable blade.

To avoid the nasal passage of the nose from being injured during nose

hair trimming, the teeth of the stationary blade are each rounded at its outer end so as to reduce the sharpness of outer edges of the stationary blade. The stationary blade is of a width larger than that of the movable blade so that the teeth on the two sides of the movable blade do not extend outward of the teeth on the two sides of the stationary blade.

The stationary blade and the movable blade are substantially rectangular in shape. In a preferred embodiment, distance between the teeth on the movable blade and the stationary blade on the first cutting edge is smaller than distance between the teeth on the movable blade and the stationary blade on the second cutting edge, so that the first cutting edge provides a finer trim and the second cutting edge provides a coarser trim. In other embodiments, distances between the teeth on the movable blade and the stationary blade on the first cutting edge and the second cutting edge may be the same.

A nose hair trimming arrangement suitable for trimming human nose hair in a nostril, said nose hair trimming arrangement comprising

a longitudinal cutting mechanism adapted for operational insertion into a user's nostril, said cutting mechanism including at least a plurality of blades movable relative to each other, with at least one blade including at least one cutting edge, the blades defining a plurality of cutting zones at least part of the area of relative movement swept by them; and
wherein the plurality of cutting zones extend in opposed directions at least partially along the length of the cutting mechanism.

The nose hair trimming arrangement as claimed in claim 8, wherein the cutting zones are exposed for direct contact operationally with a user.

Preferably, the nose hair trimming arrangement further comprising a housing from which the cutting mechanism extends.

Preferably, the housing includes a longitudinal insertion formation configured and adapted to be inserted longitudinally into a human nostril.

Preferably, the plurality of cutting zones extend in opposed directions at least partially along the length of the insertion formation.

The nose hair trimming arrangement as claimed in claim 8, wherein the plurality of blades includes at least one stationary blade and at least one movable blade movable relative to the stationary blade.

Preferably, the plurality of blades includes a plurality of stationary blades and a plurality of movable blades.

Preferably, the plurality of blades includes at least two movable blades movable relative to each other.

Preferably, the longitudinal cutting mechanism is received within the insertion formation.

Preferably, at least one of the blades comprises a plurality of cutting edges.

Preferably, the cutting zones extend in opposed directions at least partially along the length of the insertion formation, at an obtuse angle to each other.

Preferably, the cutting zones extend parallel to each other.

Preferably, the cutting zones extend parallel to each other and parallel to the insertion formation.

The nose hair trimming arrangement as claimed in claim 8, wherein the cutting zones extend in a direction not parallel with each other.

Preferably, at least the moveable blade extends from the insertion formation through at least one aperture in the housing.

Preferably, both the moveable blade and the stationary blade extend from the insertion formation through at least one aperture in the housing.

Preferably, both the moveable blade and the stationary blade extend from the insertion formation through a plurality of apertures in the housing.

Preferably, opposed edges of the moveable blade extends from the insertion formation through at least one aperture in the housing.

Preferably, opposed edges of both the moveable blade and the stationary blade extends from the insertion formation through at least one aperture in the housing.

Preferably, opposed edges of both the moveable blade and the stationary blade extends from the insertion formation through a plurality of apertures in the housing.

Preferably, the nose hair trimming arrangement comprises a plurality of movable blades and a plurality of stationary blades that interact to define a plurality of cutting zones.

Preferably, the relative movement between the stationary blade and the moveable blade is one or more selected from:

sliding movement;
reciprocating movement;
rotational movement;
linear movement; and
scissoring movement.

Preferably, at least one or more selected from the stationary blade and the moveable blade is U-shaped in cross section.

Preferably, one or more of the stationary blade and the moveable blade define a plurality of teeth along their cutting edges.

Preferably, the stationary blade comprises a plate defining a pair of opposed major faces and a pair of opposed edges.

Preferably, the movable blade comprises a plate defining a pair of opposed major faces and a pair of opposed edges.

Preferably, the stationary blade and the moveable blade each include cutting edges defining a plurality of teeth disposed along their opposed sides.

Preferably, linear reciprocating movement of the plurality of teeth of the stationary blade and the moveable blade relative to each other defines the plurality of cutting zones.

Preferably, the stationary blade and the moveable blade abut each other.

Preferably, the stationary blade and the moveable blade abut each other and move relative to each other to define a pair of cutting zones along opposite sides of the adjacent stationary blade and the moveable blade.

Preferably, one or more selected from the size or pitch of the teeth on one side of one or more selected from the stationary blade and the moveable blade varies from that on the opposed side.

Preferably, one or more selected from the size or pitch of the teeth on one of the opposed edge of the stationary blade is similar to that of the adjacent moveable blade's teeth.

Preferably, the stationary blade and the moveable blade are at least partially received within and extend from the insertion formation.

Preferably, the cutting edge(s) of at least one selected from the stationary blade and the moveable blade are rounded to prevent injury to a user.

Preferably, at least one or more of the stationary blade and the moveable blade are rectangular in shape.

Preferably, the widths of the stationary blade and the moveable blade are substantially the same.

Preferably, the width of one of the stationary blade and the moveable blade is larger than the other.

Preferably, the width of one of the stationary blades is larger than the moveable blade.

Preferably, the nose hair trimming arrangement further comprises a drive mechanism coupled to the cutting mechanism for driving movement of the moveable blade.

Preferably, the drive mechanism includes a mechanical linkage for translating rotational motion to linear motion.

Preferably, the drive mechanism is a reciprocating drive mechanism.

Preferably, the reciprocating drive includes a rotating member.

Preferably, the rotating member is coupleable to an electric motor.

Preferably, the drive mechanism is for coupling to a rotating member having a pin extending therefrom, and comprises

a pivot member configured and adapted to pivot about a pivot axis; said pivot member coupleable to at least one movable blade;
wherein said pivot member includes a receiving formation for receiving the pin in a sliding fashion; and
wherein the operational rotation of the pin on the rotating member causes the pin to move within the receiving formation, while causing the pivot member to pivot about the pivot axis in a reciprocating manner; thereby to move the movable blade in a linear reciprocating fashion.

Preferably, the drive mechanism comprises

a rotating member; and
a pin extending from the rotating member;
a pivot member configured and adapted to pivot about a pivot axis; said pivot member coupled to at least one movable blade;
wherein said pivot member includes a receiving formation for receiving the pin in a sliding fashion; and
wherein the operational rotation of the pin on the rotating member causes the pin to move within the receiving formation, while causing the pivot member to pivot about the pivot axis in a reciprocating manner; thereby to move the movable blade in a linear reciprocating fashion.

Preferably, the receiving formation is one selected from a recess or aperture.

Preferably, the nose hair trimming arrangement, further includes an electric motor.

In another aspect the invention may be said to consist broadly in a nose hair trimming attachment adapted for being coupled to a driver mechanism, said nose hair trimming attachment comprising a nose hair trimming arrangement as described.

In another aspect the invention may be said to consist broadly in a nose hair trimming attachment as described, further comprising a coupling mechanism for coupling the nose hair trimming attachment to a driver mechanism.

In another aspect the invention may be said to consist broadly in a nose hair trimmer comprising a nose hair trimming arrangement as claimed.

Preferably, the nose hair trimmer, further comprises a handle.

Preferably, the nose hair trimmer further comprises a power coupling arrangement for coupling the nose hair trimmer to a power source.

Preferably, the power source is one selected from a battery and mains power.

Preferably, the nose hair trimmer further comprises an electric motor for moving the movable blade.

In another aspect the present invention may be said to broadly consist in a blade arrangement for a hair trimmer, said blade arrangement comprising
at least one stationary blade for being secured to a housing in a stationary manner,
   said stationary blade having two opposed major faces and at least two opposed edges, and
   and wherein said stationary blade further includes a pair of toothed cutting regions along its two opposed edges; wherein said toothed cutting regions defines a plurality of teeth;
at least one movable blade,
   said movable blade having two opposed major faces and at least two opposed edges, and
   wherein said movable blade further includes a pair of toothed cutting regions along its two opposed edges; and
wherein said toothed cutting regions defines a plurality of teeth;
wherein said stationary blade and said movable blade are adapted and configured for moveable engagement with each other each other along at least part of each of one of their major faces, so that their toothed cutting regions are disposed at least partially adjacent each other;
and wherein the relative movement between the stationary blade and movable blade at their adjacent toothed cutting regions defines a pair of cutting zones.

Preferably, the stationary blade and movable blade are adapted and configured for being moved in a linear reciprocating manner relative to each other.

Preferably, the stationary blade and movable blade have complementary engagement formations adapted for movable engagement with each other.

Preferably, the complementary engagement formations define a track formation and a track follower formation.

Preferably, the complementary engagement formations are a channel and ridge formation.

Preferably, one selected from the pitch and size of the teeth on each side of the stationary blade is the same as that of the adjacent teeth on the movable blade.

Preferably, one selected from the pitch and size of the teeth on one edge of one or both of the stationary blade and the movable blade are different from that of the opposed edge.

Preferably, the thickness of the blade at one edge of one or both selected from the stationary blade and movable blade is reduced in comparison to the thickness at the opposed edge.

Preferably, the stationary blade and movable blade have similar widths.

Preferably, the stationary blade is wider than the movable blade.

Preferably, the stationary blade is slightly wider than the movable blade in order to avoid having the moving blade making contact in operation with the skin of a user.

Preferably, the stationary blade and movable blade are rectangularly shaped.

Preferably, the toothed edge on one major face of one or more selected from the stationary blade and the movable blade, is out of plane with the rest of the major face.

Preferably, the toothed edge on one major face of one or more selected from the stationary blade and the movable blade, is out of plane with the rest of the major face to form a first and second surface.

Preferably, the toothed edge on both major faces of one or more selected from the stationary blade and the movable blade is out of plane with the rest of the major face.

Preferably, both of the toothed edges on both major faces of one or more selected from the stationary blade and the movable blade are out of plane with the rest of the major faces.

Preferably, both of the toothed edges on both major faces of one or more selected from the stationary blade and the movable blade are out of plane with the rest of the major to define at least a first and second surface on each major face.

In another aspect, the invention maybe said to broadly consist in a hair trimmer mechanism including a blade arrangement as described.

In another aspect, the invention maybe said to broadly consist in a hair trimmer mechanism including a blade arrangement as described.

In another aspect, the invention maybe said to broadly consist in a hair trimmer including a blade arrangement as described.

In another aspect, the invention maybe said to broadly consist in a removable hair trimmer attachment including a blade arrangement as described.

In another aspect, the invention maybe said to broadly consist in a method of manufacture of a blade for a hair trimmer, comprising the steps, of
providing a planar plate of sheet material having two opposed major faces and two opposed edges;
deforming at least a portion of at least one or more of the opposed edges on at least one major face of the plate; and
grinding at one or more of the opposed edges of the plate to a thinner thickness.

Preferably, the step of deforming, deforms at least a portion of one opposed edge on at least one major face of the plate to reduce its thickness.

Preferably, the step of deforming is carried out by a press.

Preferably, the step of deforming results in a portion of the surface of that major face of the plate at that edge of the plate is out of plane with another part of that major surface.

Preferably, the step of deforming deforms both major faces of the plate so that at least a portion of at least one opposed edge on both major faces results in a portion of the surface of that major face of the plate at that edge of the plate is out of plane with another part of that major surface.

Preferably, the step of deforming further comprises cutting out the shape of teeth along one or both of the opposed edges.

Preferably, the step of deforming is carried out over two steps comprising the steps of:
deforming the plate to reduce the thickness of the plate at an edge by applying a force to the edge at a major face while supporting the opposed major face, deforming both major faces of the plate by bending it so that at least a portion of at least one opposed edge on both major faces results in a portion of the surface of that major face of the plate at that edge of the plate is out of plane with another part of that major surface.

Preferably, the step(s) of deforming is carried on to deform the full length of at least one opposed edge.

Preferably, the step(s) of deforming is carried on to deform the full length of both opposed edges.

Preferably, the step of deforming is carried out by applying force to at least a portion of one of the opposed edges.

Preferably, the step of deforming is carried out by applying force to at least a portion of both of the opposed edges.

Preferably, the step of deforming to thin the thickness of the plate is carried out by application of a force to one major face, and the step of grinding is applied to the opposed major face.

Preferably, the step of grinding is carried out over an entire face of the plate.

Preferably, the step(s) of deforming at least one or more of the opposed edges to thin the thickness of the plate is carried out by applying a force from the side of one major face while supporting the opposed major face, and the step of grinding is carried out over at least part of an opposed major face of the plate.

Preferably, the step of deforming is carried out by application of a force to one major face to deform both major faces at least one of the opposed edges, and the step of grinding is applied to the opposed major face.

Preferably, the step of deforming both major faces of the plates is carried out by applying a force to a part of one major face, while allowing the adjacent part of the opposed major face to remain unsupported.

Preferably, the step of deforming both major faces of the plate so that at least a portion of at least one opposed edge on both major faces results in a portion of the surface of that major face of the plate at that edge of the plate is out of plane with another part of that major surface is carried out by application of a force to one major face to deform both major faces at least one or more of the opposed edges, and the step of grinding is applied to the opposed major face.

Preferably, the step of deforming is carried out by application of a force to one major face to deform both major faces at both of the opposed edges.

Preferably, the step of grinding is carried out to grind the two opposed edges to a co-planar configuration.

Preferably, the step of grinding is carried out to grind the two opposed edges to a co-planar configuration simultaneously.

Preferably, the step of deforming comprises applying a force to the full edge of the plate.

Preferably, the plate is metallic.

Preferably, the method includes the step of machining at least one edge of the plate to reduce the thickness of at least a portion of the edge.

Preferably, the method includes the step of machining at least one deformed edge of the plate to reduce the thickness of at least a portion of the edge.

Preferably, the deformation of at least a portion of at least one opposed edge to thin the thickness of the plate is carried out by a hydraulic press.

Preferably, the deformation of at least a portion of at least one opposed edge to thin the thickness of the plate is carried out by transfer of kinetic energy.

Preferably, the deformation of at least a portion of at least one opposed edge to thin the thickness of the plate is carried out by transfer of kinetic energy in an impact from an impaction member.

Preferably, the step of deforming the plate includes the process of cutting teeth shapes out of the plate.

Preferably, the teeth shapes along one edges are of a different size and/or pitch to those at the opposed side.

In another aspect the invention may be said to broadly consist in a method of manufacture of a blade for a hair trimmer, comprising the steps of

providing a planar plate of sheet material having two opposed major faces and two opposed edges;
machining at least a portion of at least one opposed edge on a major face to thin the thickness of the plate; and
grinding at least the formed edge of the plate to a thinner thickness.

Preferably, the step of machining results in a portion of the surface of that major face of the plate at that edge of the plate being out of plane with another part of that major surface.

Preferably, the step of machining results in the major surface of the plate at that edge being out of plane with another part of that major surface.

Preferably, the step of grinding is carried out on a major face of the plate on an opposed side of the plate to where the machining step was carried out.

Preferably, the method includes the step of deforming at least a portion of at least one opposed edge on at least one major face.

Preferably, the method includes the step of deforming at least a portion of at least one opposed edge on at least one major face to thin the thickness of the plate.

Preferably, the step of deforming at least a portion of at least one opposed edge on a major face results in a portion of the surface of that major face of the plate at that edge of the plate being out of plane with another part of that major surface.

Preferably, the step of deforming is carried on to deform at least a portion of at least one opposed edge on both major faces results in the deformation of both major faces of the plate so that at least a portion of at least one opposed edge on both major faces results in a portion of the surface of the major faces of the plate at that edge of the plate being out of plane with another part of the major faces.

Preferably, the step of deforming is carried on to deform the full length of at least one opposed edge.

Preferably, the step of deforming is carried on to deform the full length of both opposed edges.

Preferably, the step of deforming is carried out by application of a force to one major face, and the step of grinding is applied to the opposed major face.

Preferably, the step of grinding is carried out over an entire face of the plate.

Preferably, the step of deforming one of the opposed edges is carried out by applying a pressing action from the side of one major face, and the step of grinding is carried out over at least part of an opposed major face of the plate.

Preferably, the step of deforming is carried out by application of a force to at least a portion of one major face while allowing the adjacent portion of the opposed major face to remain unsupported, thereby to deform both major faces.

Preferably, the step of deforming is carried out by application of a force to at least a portion of one major face while supporting the adjacent portion of the opposed major face, thereby to reduce the thickness of the plate at the said portion of the major face.

Preferably, the step of deforming deforms both major faces at least one of the opposed edges.

Preferably, the step of deforming deforms both of the opposed edges.

Preferably, the step of grinding is carried out to grind the two opposed edges to a co-planar configuration.

Preferably, the step of grinding is carried out to grind the two opposed edges to a co-planar configuration simultaneously.

Preferably, the step of deforming includes applying a force to the full edge of the plate.

Preferably, the step of deforming flattens both opposed edges of the plate.

Preferably, the plate is metallic.

Preferably, the deformation of at least a portion of at least one opposed edge to thin the thickness of the plate is carried out by a hydraulic press.

Preferably, the deformation of at least a portion of at least one opposed edge to thin the thickness of the plate is carried out by transfer of kinetic energy.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification [and claims] means “consisting at least in part of”. When interpreting statements in this specification [and claims] which include that term, the features, prefaced by that term in each statement, all need to be present but other features can also be present. Related terms such as “comprise” and “comprised” are to be interpreted in the same manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

The invention will now be described by way of example only and with reference to the drawings in which:

FIG. 1: shows a perspective view of the nose hair trimmer of the first embodiment.

FIG. 2: shows an enlarged cutaway perspective view of the head portion of the nose hair trimmer of the nose hair trimmer of the first embodiment.

FIG. 3: shows a cutaway perspective view of a blade arrangement inside the head portion of the nose hair trimmer of the first embodiment.

FIG. 4a: shows a perspective view of a stationary blade of the nose hair trimmer of the first embodiment.

FIG. 4b: shows a partial enlarged cutaway perspective view of FIG. 4a.

FIG. 5: shows a perspective view of the movable blade of the nose hair trimmer of the first embodiment.

FIG. 6: shows an enlarged view of the internal structure of the head portion of the nose hair trimmer of the nose hair trimmer of another embodiment.

FIG. 7: shows steps in a method of manufacture of a stationary blade and movable blade, including the steps of forming by pressing and cutting, machining and grinding;

FIG. 8: shows steps in a method of manufacture of a stationary blade and movable blade, including the steps of forming by flattening, pressing, and cutting; machining and grinding;

FIG. 9: shows steps in a method of manufacture of a stationary blade and movable blade, including the steps of forming by pressing and cutting; and grinding;

FIG. 10a: shows a mechanical linkage for translating rotational motion to linear motion; for operation with a rotating member of a reciprocating drive as shown in FIG. 11;

FIG. 10b: shows side views of the mechanical linkage as shown in FIG. 10a during operation with the rotating member of a reciprocating drive as shown in FIG. 11;

FIG. 11: shows a rotating member of a reciprocating drive for operation with the mechanical linkage for translating rotational motion to linear motion shown in FIG. 10;

FIG. 12: shows a nose hair trimmer attachment;

FIG. 13: shows a perspective view of a first embodiment of a blade arrangement;

FIG. 14: shows an end view of a first embodiment of a blade arrangement;

FIG. 15: shows an top view of a first embodiment of a blade arrangement;

FIG. 16: shows a perspective view of a second embodiment of a blade arrangement;

FIG. 17: shows an end view of a second embodiment of a blade arrangement;

FIG. 18: shows an top view of a second embodiment of a blade arrangement;

FIG. 19: shows a perspective view of a third embodiment of a blade arrangement;

FIG. 20: shows an end view of a third embodiment of a blade arrangement;

FIG. 20: shows an top view of a third embodiment of a blade arrangement;

FIG. 22: shows a perspective view of a fourth embodiment of a blade arrangement;

FIG. 23: shows an end view of a fourth embodiment of a blade arrangement; and

FIG. 24: shows an top view of a fourth embodiment of a blade arrangement.

### DETAILED DESCRIPTION OF THE INVENTION

With reference to the figures, in which similar features are generally indicated by similar numerals, a blade arrangement according to a first aspect of the invention is generally indicated by the numeral 1000, a nose hair trimming arrangement by the numeral 2300, a nose hair trimmer by the numeral 3000, and a nose hair trimmer attachment by the numeral 4000.

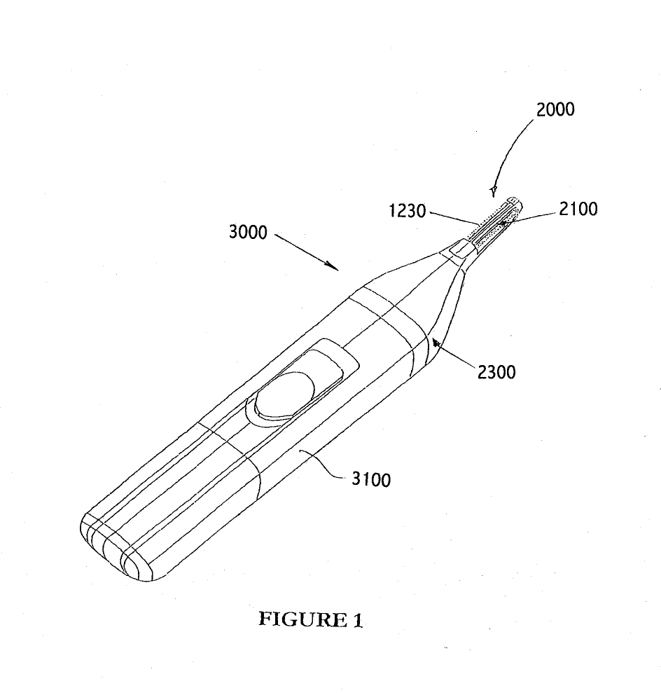

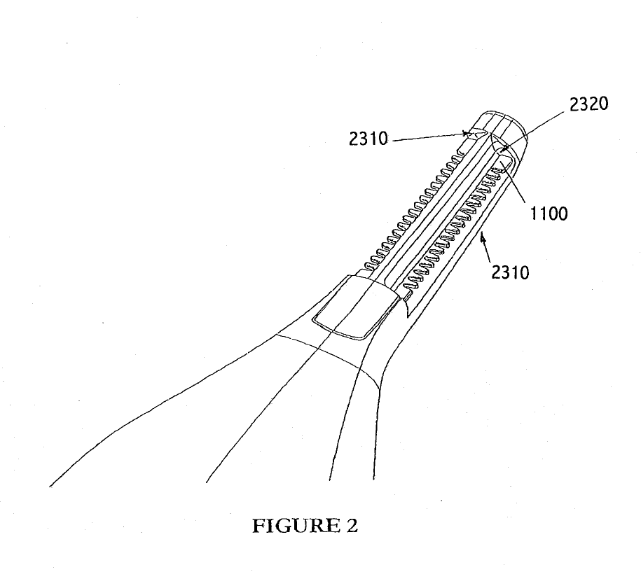

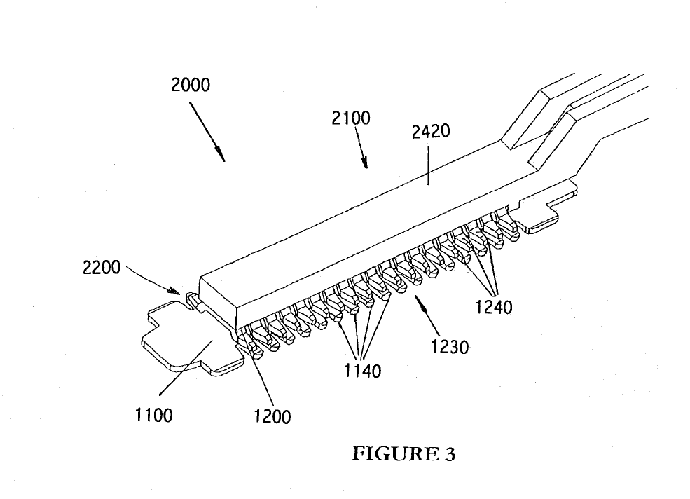

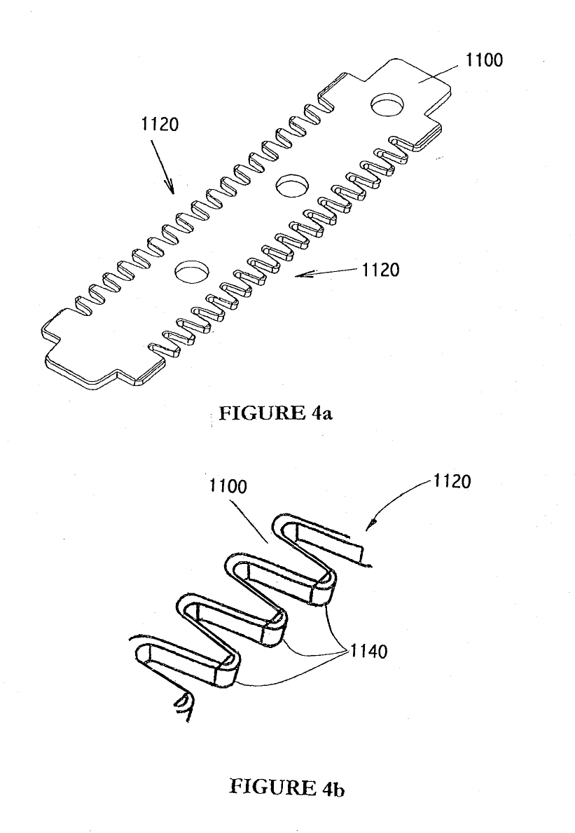

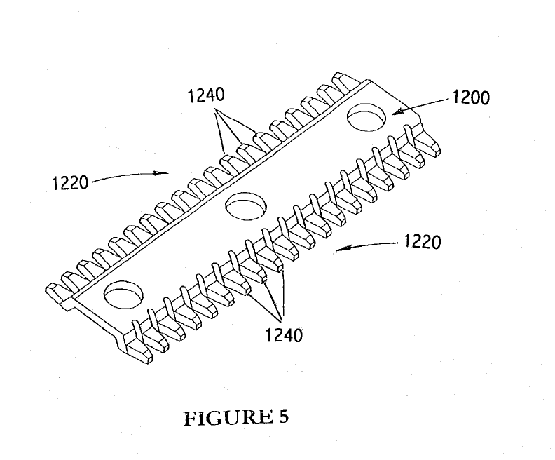

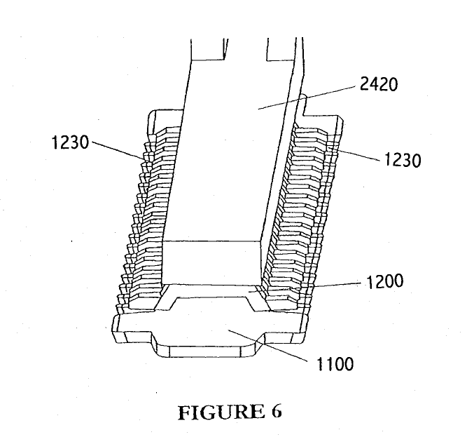

In a first aspect, as illustrated in figures, a nose hair trimmer 3000 according to one aspect of the invention comprises FIGS. 1-5, the present embodiment comprises a casing or housing 2300 which has a head portion or insertion formation 2310. The insertion formation 2310 is configured and adapted to be inserted longitudinally into a human nostril (not shown). The nose hair trimmer 3000, also includes a nose hair trimming arrangement 2000. The nose hair trimming arrangement 2000 further comprises a longitudinal cutting mechanism 2100, the cutting mechanism 2100 is adapted for operational insertion into a user's nostril. The cutting mechanism 2100 includes a plurality of blades 2200 moveable relative to each. In the embodiment shown in FIGS. 1-3, the cutting mechanism comprises a stationary blade 1100 and a movable blade 1200 movable relative to each other, however it is envisaged that the cutting mechanism could include a number of other blade arrangements 1000 as described in more detail below. Both the stationary blade 1100 and the movable blade 1200 are substantially rectangularly shaped, with the stationary blade 1100 including a plurality of teeth 1140 disposed on two opposite longitudinal cutting edges 1120 thereof, and a movable blade 1200 with a plurality of teeth 1240 disposed on two opposite longitudinal cutting edges 1220 thereof.

The movable blade 1200 is driven by a driving unit in the form of a reciprocating drive mechanism 2400, to move in a linear reciprocating manner against the stationary blade 1100 so that the teeth 1140 on one of the longitudinal cutting edges 1120 of the stationary blade 1100 and the teeth 1240 on one of the longitudinal cutting edges 1220 of the movable blade 1200 cooperate with each other to define a cutting zone 1230, and the teeth on the other longitudinal side of the stationary blade 1100 and the teeth on the other longitudinal side of the movable blade 1200 cooperate with each other to define a another cutting zone 1230. The cutting zones 1230 are located over at least part of the area of relative movement swept by the blades 2200. The plurality of cutting zones 1230 extend in opposed directions at least partially along the length of the cutting mechanism 2100.

It is envisaged that in alternative embodiments (not shown), a plurality of blades moving relatively to each other, could cooperate to create a plurality of cutting zones. In this regard, a single movable blade could cooperate with a plurality of movable blades and vice versa. Alternately, a plurality of movable blades could cooperate with each other to create a plurality of cutting zones 1230.

In a preferred embodiment as described in more detail below, the movable blade 1200 and the stationary blade 1100 each are comprised of a metallic planar plate having opposed major faces that abut each other at least partially. Their cutting edges 1220, 1120 lie adjacent each other.

In the embodiment shown in FIGS. 1-3 and 12, the cutting mechanism 2100 is received within the insertion formation 2310, and extends through a pair of apertures 2320 in the insertion formation 2310 along its length to define exposed cutting zones 1230 outside of the insertion formation 2310 for direct contact operationally with a user. However this need not be the case, and in another embodiment (not shown) the cutting mechanism 2100 can extend from a main body of a housing 2300 without being housed within such an insertion formation 2310 to provide exposed cutting zones for direct contact operationally with a user. Further, a single aperture (not shown) or slot in the housing 2300 can be provided through which the cutting mechanism 2100 can extend.

In the embodiments shown, the cutting zones 1230 extend from the longitudinal axis of the insertion formation 2310 in opposed directions. However, this need not necessarily be the case, and the cutting zones 1230 could (when viewed along the longitudinal axis) the extend at an obtuse angle to each other from the longitudinal axis of the insertion formation 2310 or cutting mechanism 2100 (or close to them).

Further, while the cutting zones 1230 shown in the embodiments extend parallel to eth longitudinal axis of the insertion formation 2310 or cutting mechanism 2100, this need not be the case. In fact the cutting zones could extend at an angle to the longitudinal axis of one or both of the insertion formation 2310 or cutting mechanism 2100. In alternative embodiments (not shown), the plurality of cutting zones 1230 need not even be parallel with each other.

In the embodiment shown, the reciprocating drive mechanism 2400 comprises a mechanical linkage 2410 and a rotating member 2500. The mechanical linkage 2410 comprises a driving arm 2420 coupled to the movable blade 1200 to move it, and a pivot member 2420 connected to the driving arm 2420. The pivot member 2420 is pivotably attached to the housing 2300 to move about an axis. The pivot member 2420 is configured to engage with a rotating member 2500. The rotating member 2500 is adapted to be moved in a rotating manner by an electrical motor (not shown), and an off-centre pin 2510 extends from it. The pin is received into a receiving formation 2430 in the pivot member 2420 in the form of a slot 2440, but which in other embodiments may be a recess, aperture or other similar suitable formation. As the off-centre pin 2510 rotates with the rotating member 2500, it moves along the slot 2440 in a sliding fashion in one direction, and causes the pivoting member to pivot about the axis A in a reciprocating fashion in another direction. This reciprocating pivoting movement of the pivot member 2420 causes the movable blade 1200 to move along the stationary blade 1100 in a linear reciprocating manner.

In this way, the reciprocating rotational movement of an electrical motor is translated into linear reciprocating movement by the movable blade 1200.

The driving arm 6 is securely connected to the movable blade 1200 to drive linear reciprocating movement of the movable blade 3. However, in another embodiment, it is envisaged that the relative movement between the blades 2200 need not be linear reciprocating movement, but could also be one or more selected from sliding movement, reciprocating movement, rotational movement, linear movement and scissoring movement.

The structure and operation of the driving unit to drive the linear reciprocating movement of the movable blade 1200 is commonly-known in the art, so the details are not further disclosed herein.

The insertion formation 2310 is in shape and size adapted to be inserted into a human nose. The upper side of the insertion formation 2310 is for housing the driving arm 2420 of the mechanical linkage 2410.

In one preferred embodiment, to avoid the nasal passage of the nose of a user from being injured during nose hair trimming, the teeth of the stationary blade 1100 are each rounded at their edges so as to reduce the sharpness of outer edges of the stationary blade 1100.

In yet another preferred embodiment, the stationary blade 1100 is of a width larger than that of the movable blade 1200 so that the teeth 1240 on the two cutting edges 1220 of the movable blade 1200 do not extend outward of the teeth 1140 on the two cutting edges 1120 of the stationary blade 1100.

In the embodiment shown in FIGS. 1-5, the size and/or pitch of the teeth 1140, 1240 on the movable blade 1200 and the stationary blade 1100 on the one cutting zone 1230 is the same as the distance between the teeth 1240, 1140 on the movable blade 1200 and the stationary blade 1100 on the opposed cutting zone 1230.

However, it is envisaged that in an alternative embodiment, the size or pitch of the teeth 1140 1240 of the movable blade and stationary blade at one set of adjacent cutting edges 1220, 1120 could be different from the size and/or pitch of the teeth 1140 along the opposed adjacent cutting edges 1220, 1120. In this way the cutting zone 1230 at one side of the cutting mechanism 2100 would be able to provide a closer trim than the opposed cutting zone 1230.

In the embodiments shown in FIG. 1 the nose hair trimming arrangement 2000 is incorporated as a part of a nose hair trimmer 3000. The nose hair trimmer 3000 will further include a handle 3100 for allowing a user to hold the nose hair trimmer 3000, and a power coupling arrangement (not shown) for coupling the electrical motor to a source of electrical power. It is envisaged that the power coupling arrangement could couple the electrical motor to the electric mains, or to a mobile power source such as a battery, fuel cell, or similar power source.

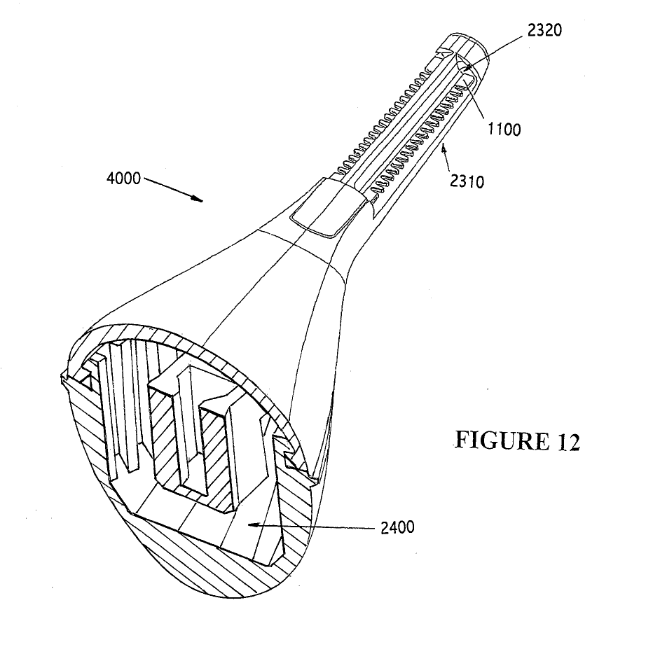

However it is envisaged that in another embodiment shown in FIG. 12, the nose hair trimming arrangement 2000 is incorporated into a nose hair trimming attachment 4000 that is removably attachable to a driver (not shown).

It is envisaged that is such an embodiment, the mechanical linkage 2410 will be located on the nose hair trimming attachment 4000, and the rotating member to the driver. The driver will also include a handle, an electrical motor and a coupling between the electrical motor and the rotating member 2500. The nose hair trimming attachment 4000 will be removably coupleable to the driver by a coupling mechanism (not shown) including coupling formations such as bayonet type formations, thread type formations, or the like.

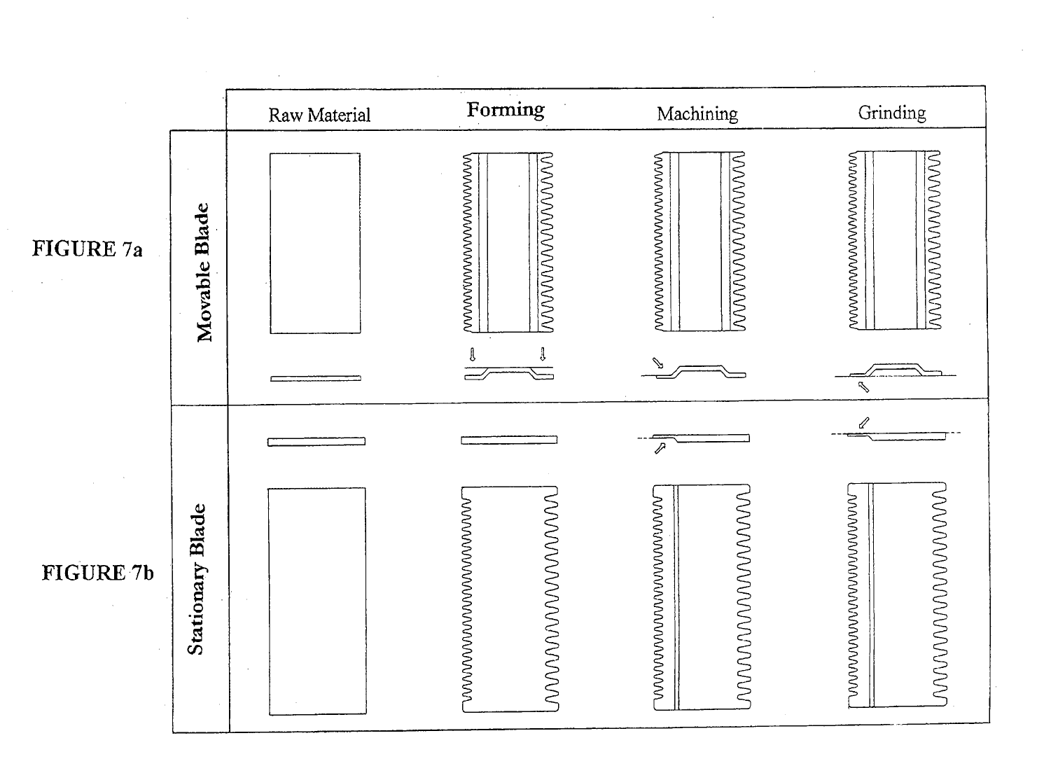

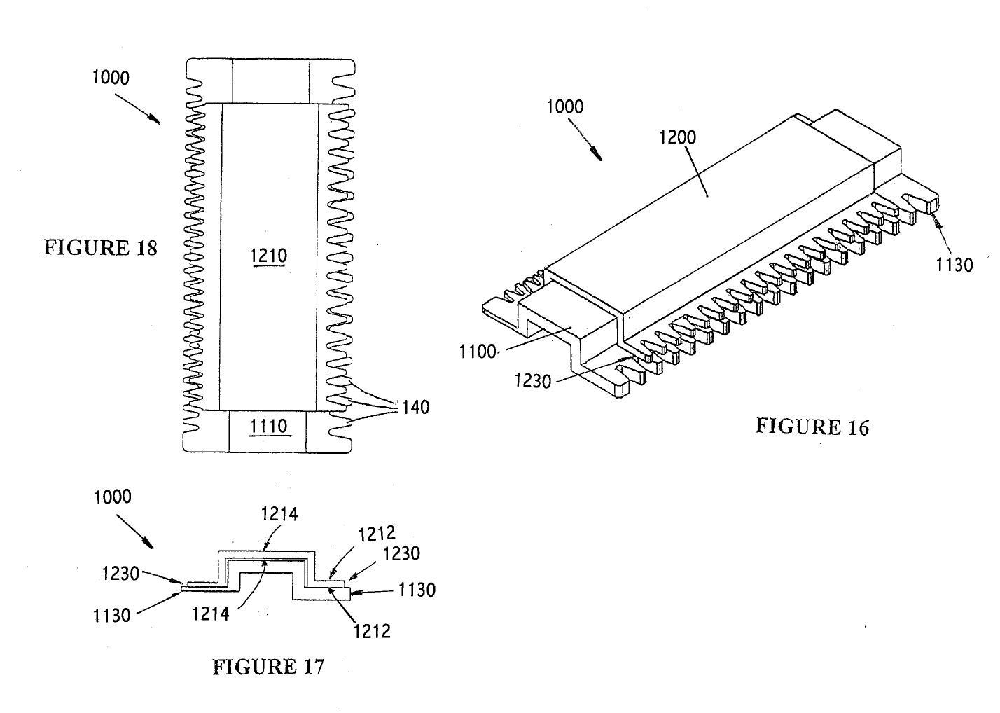

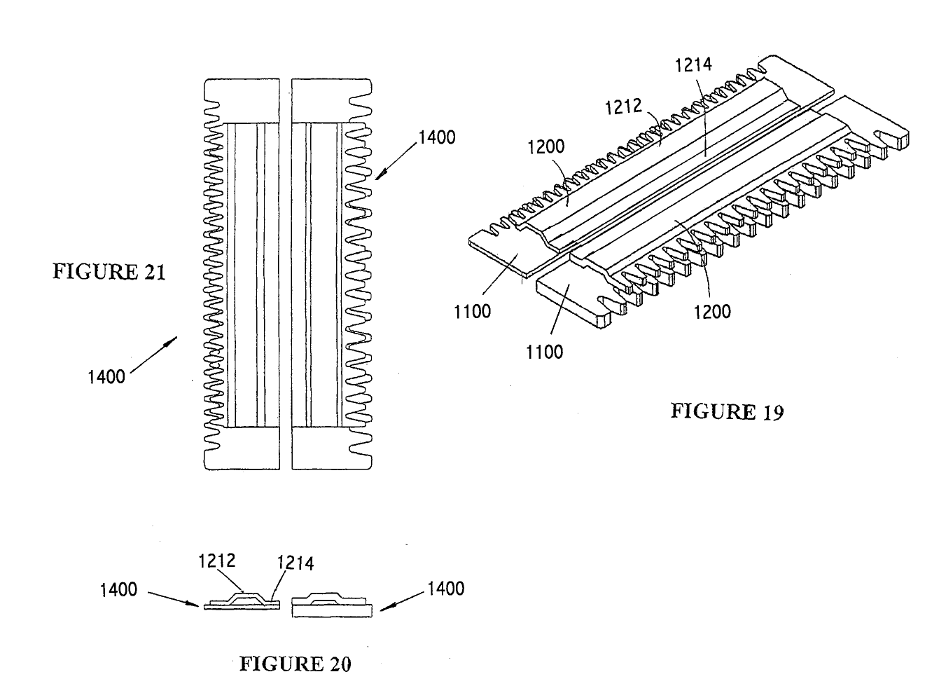

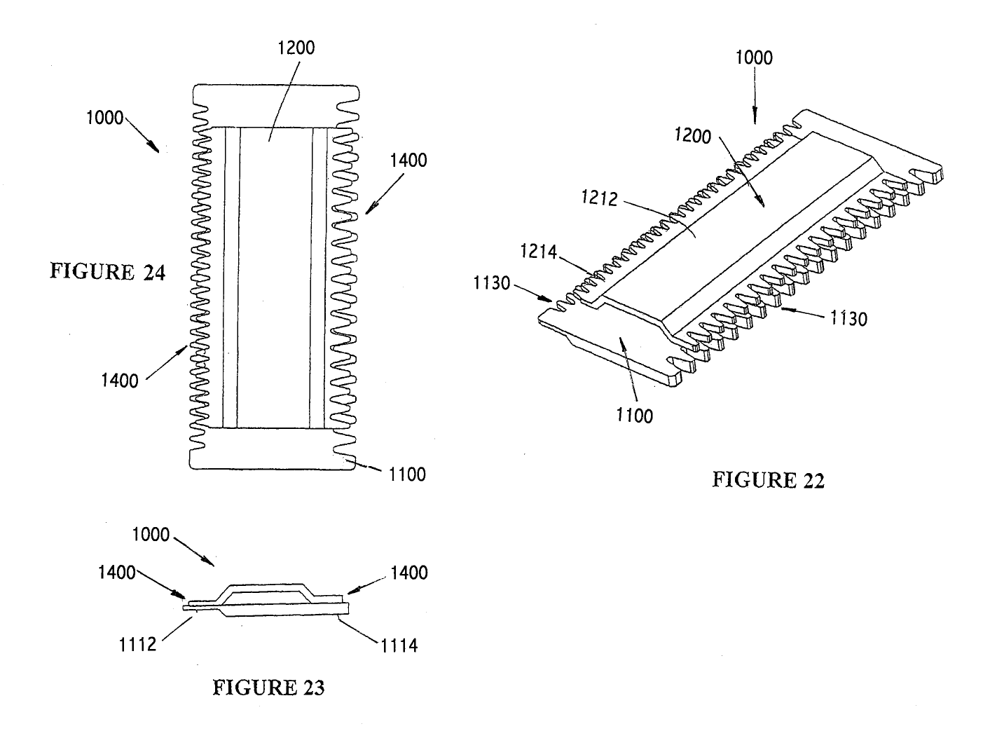

With further reference to FIGS. 7-9 and 13-24, in which similar features are generally indicated by similar numerals, a blade arrangement according to a first aspect of the invention is generally indicated by the numeral 1000.

In one embodiment now described, there is provided a blade arrangement 1000 for a hair trimmer. The blade arrangement 1000 comprises a stationary blade 1100 and a movable blade 1200. The stationary blade 1100 is for being secured to a housing of the hair trimmer in a stationary manner, and is rectangularly shaped with two opposed major faces 1110 and two opposed lengthwise edges 1120, although it is envisaged that it could be a variety of other shapes such as square, triangular, or any other suitable shape.

The stationary blade 1010 further includes a pair of toothed cutting regions 1130 along its two opposed edges 1120. The toothed cutting regions 1130 define a plurality of teeth 1140.

The moveable blade 1200 also having two opposed major faces 1210 and two opposed edges 1220 corresponding to two toothed cutting regions 1230 on which a plurality of teeth 1240 are defined.

The stationary blade 1100 and the movable blade 1200 are adapted and configured for moveable engagement with each in use. It is envisaged that in operation they will abut each other at one of their respective major faces, so that their respective toothed cutting regions 1130, 1230 are disposed at least partially adjacent each other.

The stationary blade 1100 and the movable blade 1200 will, in operation, be moved relative to each other by a reciprocating drive mechanism 2400, so that the relative movement between the stationary blade 1100 and movable blade 1200 at the area swept by their adjacent toothed cutting regions 1130, 1230 defines a pair of cutting zones.

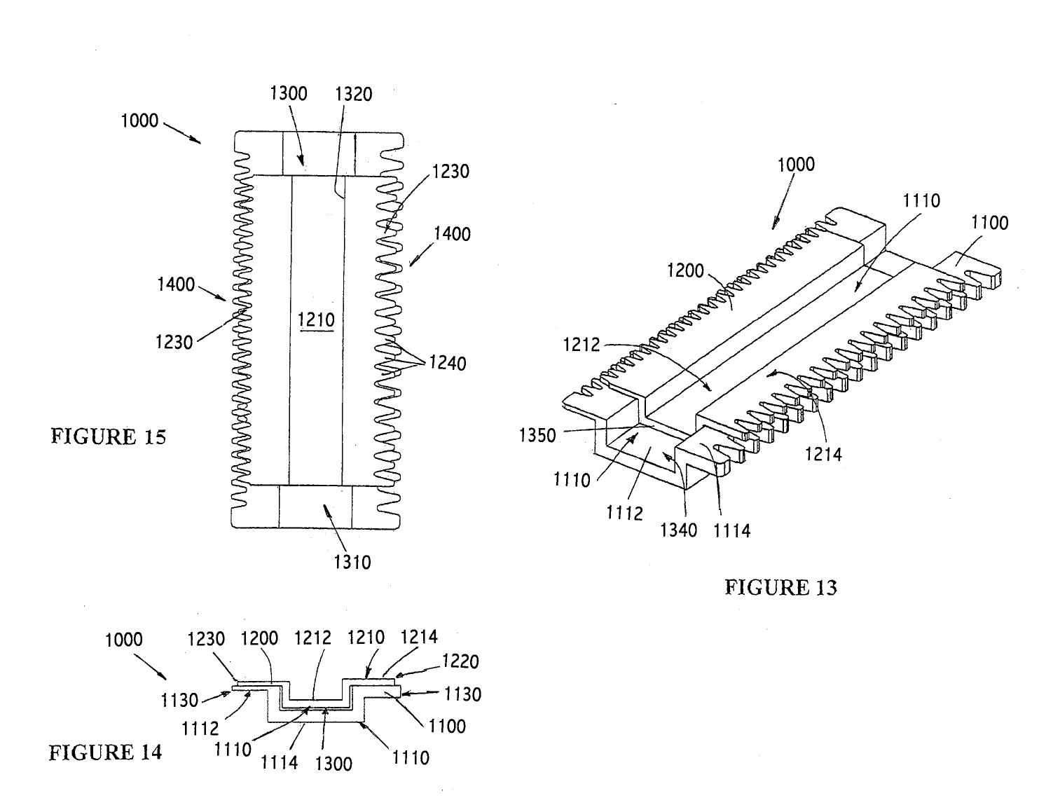

In a preferred embodiment as shown in FIGS. 13-24 the stationary blade 1100 and movable blade 1200 are adapted and configured for being moved in a linear reciprocating manner relative to each other. In this configuration, their toothed cutting regions 1130, 1230 are substantially in alignment, and overlap with each other.

In a preferred embodiment, the stationary blade 1100 and movable blade 1200 include complementary engagement formations 1300 adapted for movable engagement with each other in a linear reciprocating fashion. As shown in FIGS. 13-18, in one preferred embodiment the complementary engagement formations 1300 define a track formation 1310 and a track follower formation 1320, in the form of a channel 1340 and ridge formation 1350.

However in alternate embodiments the complementary engagement formations 1300 could be of a wide variety of shapes and configurations. For example the channel 1340 and ridge formation 1350 could instead be a slot (not shown) through one of the stationary blade 1100 and movable blade 1200, and the ridge could be a pin formation (not shown). Alternately, a wide variety of cam surfaces (not shown) and cam follower formations (not shown) could be used.

In a preferred embodiment, the pitch and size of the teeth 1140, 1240 of both the stationary blade 1100 and movable blade 1200 will be similar, although this need not necessarily be the case.

In another embodiment, the teeth 1140, 124 of one of the toothed cutting regions 1130, 1230 will be of a different size and/or pitch to the teeth 1140, 124 of the toothed cutting regions 1130, 1230 on the opposed edge 1120, 1220.

In yet another embodiment, it is envisaged that the thickness of one of the opposed edges 1120, 1220 of the will be reduced in comparison to the thickness of the edge 1120, 1220 on an opposed side. In this way, one edge 1120, 1220 can have an enlarged size and/or pitch of teeth 1140, 1240 and be thicker and more robust than the other side. This more robust, thicker cutting region 1130, 1230 can be used to trim longer hair quickly and conveniently, while the other cutting region 1130, 1230 having a reduced thickness and smaller size and pitch of teeth 1140, 1240 can be used for trimming hair for a smoother and cleaner finished result.

In one embodiment, the rectangularly shaped stationary blade and movable blade have similar widths, although in a preferred embodiment it is envisaged that the width of the stationary blade 1100 will be marginally wider than the movable blade 1200, to help prevent the movable blade making direct contact with a user's skin.

In the embodiments shown in the figures, the toothed cutting regions 1130, 1230 of one or both of the stationary blade 1100 and movable blade 1200 extend along edges 1120, 1220 associated with the length of the stationary blade 1100 and movable blade 1200. However it will be appreciated that the toothed cutting regions 1130, 1230 could extend along edge associated with their width. Further, for example if the stationary blade and movable blade have a triangular shape, the toothed cutting regions 1130, 1230 could extends diagonally along a diagonal edge.

As may be seen in FIGS. 7b, 8b, and 9b, in one embodiment, the opposed lengthwise edges 1120, 1220 of the stationary blade 1100 and movable blade 1200 can be manufactured (as described below) so that the surface of the major face 1110, 1210 at the edge 1120, 1220 is out of plane with the rest of that major face 1110, 1210, but is not on the opposed major face 1110, 1210. However, in the embodiment shown in FIGS. 7a, 8a and 9a, the face of the major face 1110, 1210 at the edge 1120, 1220 is out of plane with the rest of that major face 1110, 1210 on both of the major faces to form a first surface and second surface on each major face. It is envisaged that a plurality of other surfaces could be created on each major face.

As shown in FIGS. 7a, 8a and 9a the surface of one or both of the major faces 1110, 1210 at the toothed edges 1120, 1220 can be out of plane with the rest of their respective major faces 1110, 1210 to define at least a first and second surface on each major face.

It is anticipated that the blade arrangement will be typically used in a hair trimmer 3000 as part of a hair trimmer arrangement 2000 for a hair trimmer, possibly one similar to that described above.

Alternately, it is envisaged that the blade arrangement will be used as part of a used in a hair trimmer attachment 4000 for removable attachment to a drive mechanism. According to a further aspect of the invention, the blade arrangement 1000 as described above will be manufactured according to a novel and inventive method of manufacture of a blade for a hair trimmer.

In a first aspect, the manufacturing method comprises a series of steps that can be applied to manufacture the movable blade or the stationary blade. These steps will be described below with reference to the FIGS. 7-9. It should be noted that the arrows of the FIGS. 7-9 refer to the direction from which that process is applied.

The methods described below include various combinations of the steps of deforming, machining and grinding.

It is envisaged that the step of deforming the plate could include one of three different types of sub-steps.

The step of deforming could include the sub-step of stamping it in a press and/or cutting mechanism while not providing support to the opposed major face, to cause the plate (i.e. both major faces) at the applied force to deform to a new level relative to that of the remainder of the plate, so that it is no longer coplanar with it, and is out of plane (i.e. give it a three dimensional form). This sub-step is indicated in the figures under the heading “forming” and will be referred to as such hereafter.

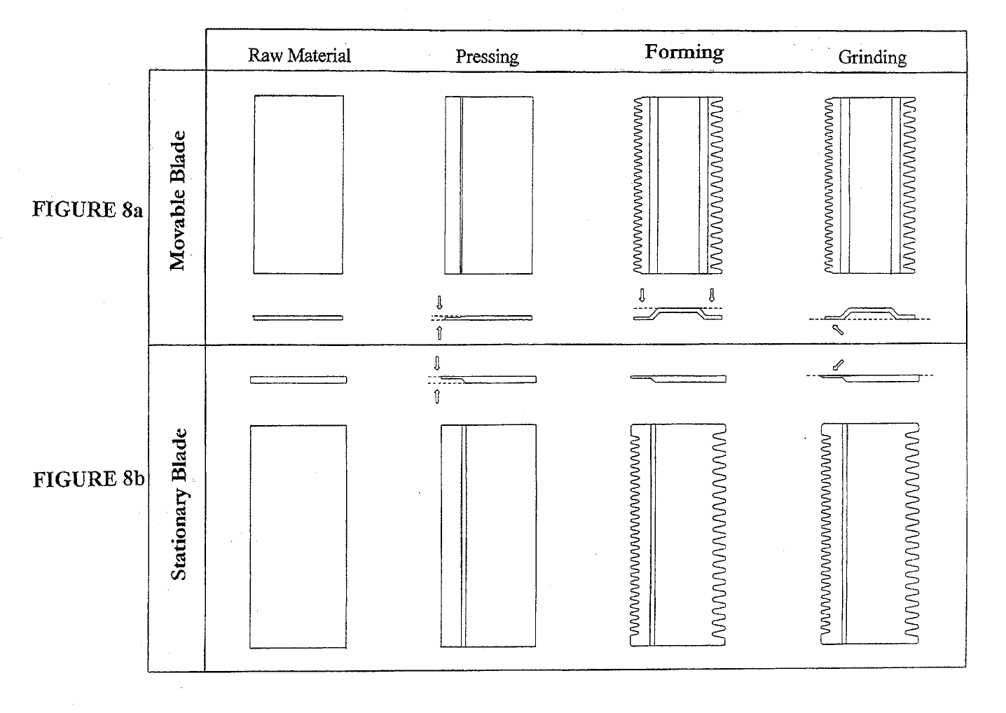

The step of deforming also generally includes the sub-step of cutting the teeth shape into the plate. This process of cutting the teeth shape by cutting is also generally included under the label of “forming” in the figures, since it relies on the application of a large force by a machine such as a hydraulic die press tool or the like. However in FIGS. 7b and 8b, the step of forming only includes the step of cutting the teeth shape without other forming of the major faces.

The step of deforming could also include a sub-step of applying a large force to part of a major face while supporting the opposed major face, to thereby cause the major face to which the large force is applied to, to flatten out, causing a change in levels of that major face, but not to the opposed major face. This sub-step of deforming is shown in the figures under the heading “pressing” and will be referred to as such hereafter.

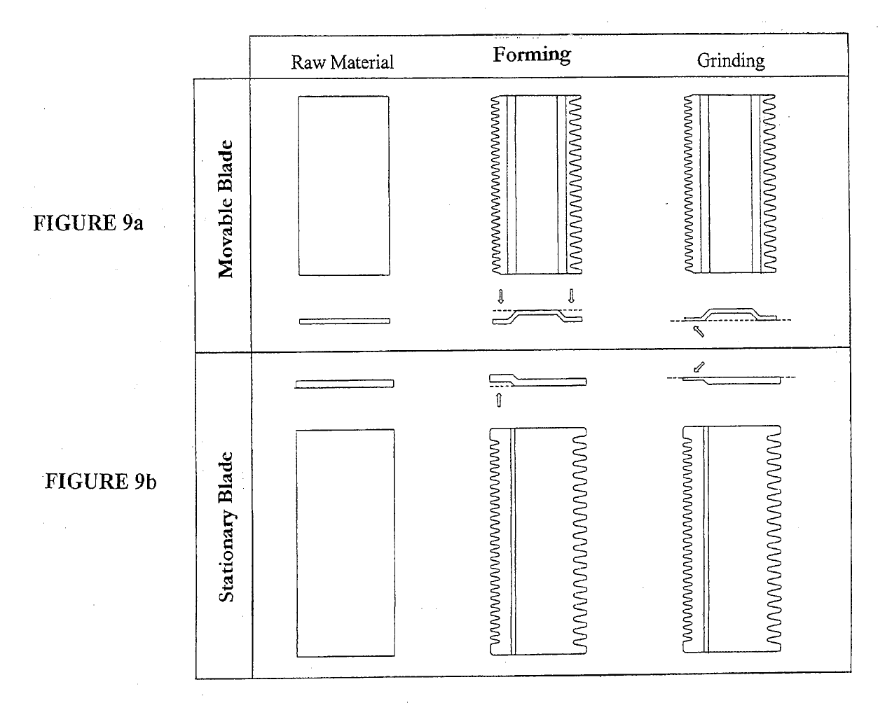

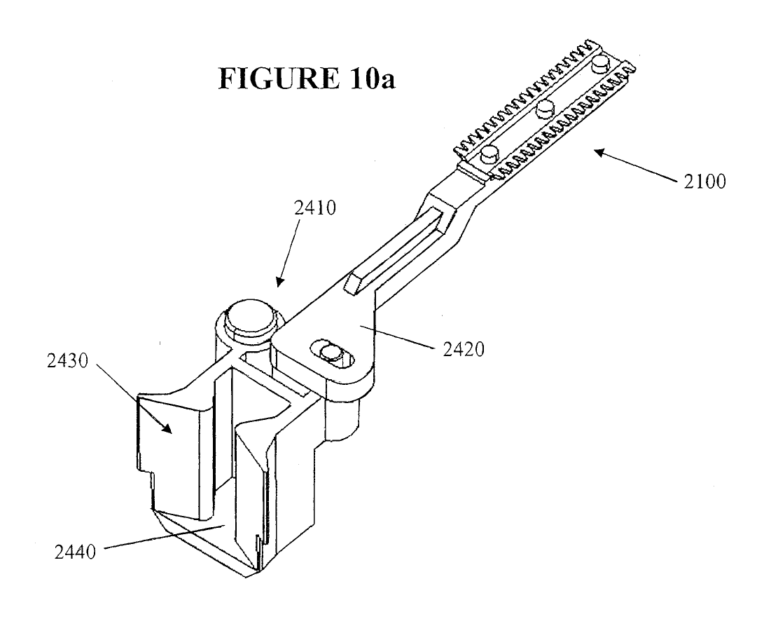

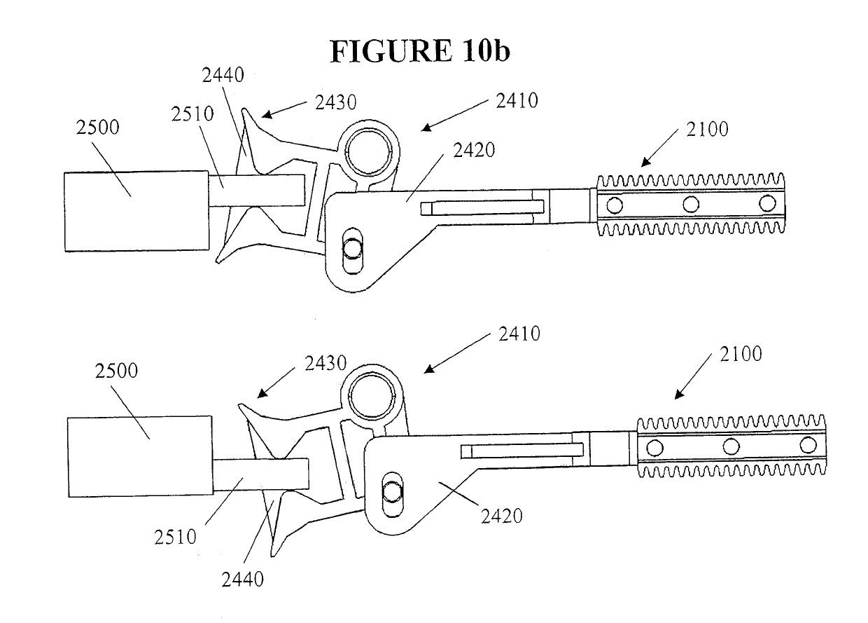

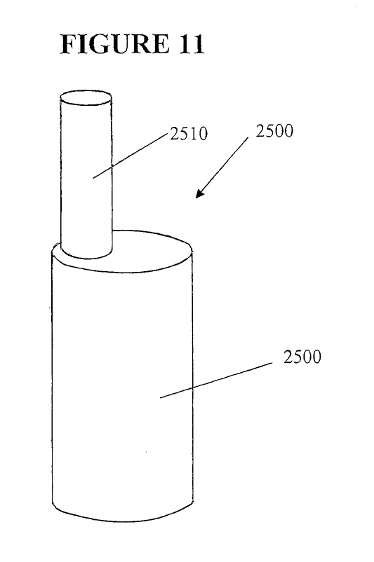

Referring first to FIG. 9, a preferred method comprises the first step of providing a preferably rectangular planar plate of metallic sheet material having two opposed major faces and two opposed edges. It is envisaged that such a plate could be provided in long lengths, which are later cut to specific lengths required for the blades.

In the method shown in FIGS. 9a and 9b, forming the toothed cutting regions 1130, 1230 to a different plane while cutting the teeth shapes will occur on one or both edges 1120, 1220, and affect both major faces 1110 1210.

After this step of deformation, the out of plane surfaces of the toothed cutting regions 1130, 1230 that are raised relative to the rest of the major faces can then be grinded down in a grinding process as shown in FIG. 9, so that the toothed cutting regions 1130, 1230 are thinner than the rest of the plate, and to sharpen the teeth to the required sharpness. In one preferred grinding step, one of the toothed cutting regions 1130, 1230 is ground down more than the other, to make a thinner set of teeth 1140, 1240 on one side of the plate. This is shown in FIG. 9a.

In another alternative to this method as shown in FIG. 7a, it is envisaged that after the step of deforming the plate by stamping it in a press and/or cutting mechanism to cause the lengthwise edge or edges of the plate in the region where the toothed cutting regions 1130, 1230 will be, to move out of plane with the remainder of the major surface, there will be included a step of machining one or both of the toothed cutting regions 1130, 1230 to make one or both of the toothed cutting regions 1130, 1230 thinner than the rest of the plate. As shown in FIG. 7b, the step of machining can be carried out without the step of forming to create different levels on the major surfaces of the plate—however, the teeth shape still needs to be cut into the plate in a deformation step.

After this step shown in FIGS. 7a and 7b, a similar grinding process is followed as described above, except that the toothed cutting regions 1130, 1230 can be ground down equally (since one toothed cutting region may already be thinner than the other if only one is machined in the machining step).

As an alternative to the step of machining one side more than the other, which may be an expensive and time consuming process, it is envisaged that the step of pressing (a subset of the step of deformation) can be used to deform one side more than the other by flattening it out. In one preferred method, the step of deformation to reduce the thickness of one or more of the toothed cutting regions 1130, 1230 would be carried out by a hydraulic press or by mechanical leverage to flatten out one or both of the toothed cutting regions 1130, 1230 while supporting the opposed major face. This is shown in FIGS. 8a and b under the column “Pressing”. It should be noted that such flattening will only affect the level of one major face.

Once the toothed cutting regions 1130, 1230 have been flattened, the opposed major face can be grinded to sharpen the teeth and reduce the thickness of the plate further.

It should be noted that the shape of the teeth can be cut into the plate during the deformation step is carried out after the step of pressing the plate to flatten it (as shown in FIGS. 8a and 8b). It is envisaged that this could be carried out before pressing it, but this is not preferred, since the step of pressing it would make for inaccurate teeth shapes.

In this way, a stationary blade 1100 or movable blade 1200 that are symmetrical or unsymmetrical may be manufactured to a high degree of accuracy, and with relatively low cost penalties.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

In addition, where features or aspects of the invention are described in terms of Markush groups, those skilled in the art will recognize that the invention is also thereby described in terms of any individual member or subgroup of members of the Markush group.

As to a further discussion of the manner of usage and operation of the present invention, the same should be apparent from the above description.

Accordingly, no further discussion relating to the manner of usage and operation is provided.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

The present invention is capable of other embodiments and of being practiced and carried out in various ways. It is to be understood that the phraseology and terminology employed herein are for the purpose of description and should not be regarded as limiting.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to falling within the scope of the invention.

What is claimed is:

1) A nose hair trimmer with dual cutting edges which comprises
a) a stationary blade with a plurality of teeth disposed on two opposite longitudinal sides thereof;
b) a movable blade with a plurality of teeth disposed on two opposite longitudinal sides thereof, and the movable blade is driven by a driving unit to move in a linear reciprocating manner against the stationary blade so that the teeth on one of the longitudinal sides of the stationary blade and the teeth on one of the longitudinal sides of the movable blade cooperate with each other to define a first cutting edge, and the teeth on the other longitudinal side of the stationary blade and the teeth on the other longitudinal side of the movable blade cooperate with each other to define a second cutting edge; and
c) a casing having a head portion in shape and size adapted to be inserted into a human nose, and the head portion is provided with two longitudinal openings disposed opposite to each other for exposing the first cutting edge and the second cutting edge respectively, so that the first cutting edge and the second cutting edge are positioned substantially parallel to a longitudinal axis of a nasal passage of a human nose when the head portion is inserted into the nose.

2) The nose hair trimmer with dual cutting edges as claimed in claim 1, wherein the two longitudinal openings are provided on two opposite sides at a lower part of the head portion, and an upper part of the head portion is used for housing a driving arm of the driving unit which is securely connected to the movable blade.

3) The nose hair trimmer with dual cutting edges as claimed in claim 1, wherein the teeth of the stationary blade are each rounded at its outer end so as to reduce the sharpness of outer edges of the stationary blade.

4) The nose hair trimmer with dual cutting edges as claimed in claim 1, wherein the stationary blade is of a width larger than that of the movable blade so that the teeth on the two longitudinal sides of the movable blade do not extend outward of the teeth on the two longitudinal sides of the stationary blade.

5) The nose hair trimmer with dual cutting edges as claimed in claim 1, wherein the stationary blade and the movable blade are substantially rectangular in shape.

6) The nose hair trimmer with dual cutting edges as claimed in claim 1, wherein distance between the teeth on the movable blade and the stationary blade on the first cutting edge is smaller than distance between the teeth on the movable blade and the stationary blade on the second cutting edge, so that the first cutting edge provides a finer trim and the second cutting edge provides a coarser trim.

7) The nose hair trimmer with dual cutting edges as claimed in claim 1, wherein distances between the teeth on the movable blade and the stationary blade on the first cutting edge and the second cutting edge are the same.

8) A nose hair trimming arrangement suitable for trimming human nose hair in a nostril, said nose hair trimming arrangement comprising
a) a longitudinal cutting mechanism adapted for operational insertion into a user's nostril, said cutting mechanism including at least a plurality of blades movable relative to each other, with at least one blade including at least one cutting edge, the blades defining a plurality of cutting zones at least part of the area of relative movement swept by them; and
b) wherein the plurality of cutting zones extend in opposed directions at least partially along the length of the cutting mechanism.

9) The nose hair trimming arrangement as claimed in claim 8, wherein the cutting zones are exposed for direct contact operationally with a user.

10) The nose hair trimming arrangement as claimed in claim 8, further comprising a housing from which the cutting mechanism extends.

11) The nose hair trimming arrangement as claimed in claim 10, wherein the housing includes a longitudinal insertion formation configured and adapted to be inserted longitudinally into a human nostril.

12) The nose hair trimming arrangement as claimed in claim 11, wherein the plurality of cutting zones extend in opposed directions at least partially along the length of the insertion formation.

13) The nose hair trimming arrangement as claimed in claim 8, wherein the plurality of blades includes at least one stationary blade and at least one movable blade movable relative to the stationary blade.

14) The nose hair trimming arrangement as claimed in claim 8, wherein the plurality of blades includes a plurality of stationary blades and a plurality of movable blades.

15) The nose hair trimming arrangement as claimed in claim 8, wherein the plurality of blades includes at least two movable blades movable relative to each other.

16) The nose hair trimming arrangement as claimed in claim 11, wherein the longitudinal cutting mechanism is received within the insertion formation.

17) The nose hair trimming arrangement as claimed in claim 8, wherein at least one of the blades comprises a plurality of cutting edges.

18) The nose hair trimming arrangement as claimed in claim 11, wherein the cutting zones extend in opposed directions at least partially along the length of the insertion formation, at an obtuse angle to each other.

19) The nose hair trimming arrangement as claimed in claim 8, wherein the cutting zones extend parallel to each other.

20) The nose hair trimming arrangement as claimed in claim 11, wherein the cutting zones extend parallel to each other and parallel to the insertion formation.

21) The nose hair trimming arrangement as claimed in claim 8, wherein the cutting zones extend in a direction not parallel with each other.

22) The nose hair trimming arrangement as claimed in claim 13, wherein at least one moveable blade extends from the insertion formation through at least one aperture in the housing.

23) The nose hair trimming arrangement as claimed in claim 22, wherein both the moveable blade and the stationary blade extend from the insertion formation through at least one aperture in the housing.

24) The nose hair trimming arrangement as claimed in claim 22, wherein both the moveable blade and the stationary blade extend from the insertion formation through a plurality of apertures in the housing.

25) The nose hair trimming arrangement as claimed in claim 22, wherein opposed edges of the moveable blade extends from the insertion formation through at least one aperture in the housing.

26) The nose hair trimming arrangement as claimed in claim 22, wherein opposed edges of both the moveable blade and the stationary blade extends from the insertion formation through at least one aperture in the housing.

27) The nose hair trimming arrangement as claimed in claim 22, wherein opposed edges of both the moveable blade and the stationary blade extends from the insertion formation through a plurality of apertures in the housing.

28) The nose hair trimming arrangement as claimed in claim 8, comprising a plurality of movable blades and a plurality of stationary blades that interact to define a plurality of cutting zones.

29) The nose hair trimming arrangement as claimed in claim 8, wherein the relative movement between the blades is one or more selected from:
a) sliding movement;
b) reciprocating movement;
c) rotational movement;
d) linear movement; and
e) scissoring movement.

30) The nose hair trimming arrangement as claimed in claim 13, wherein at least one or more selected from the stationary blade and the moveable blade is U-shaped in cross section.

31) The nose hair trimming arrangement as claimed in claim 13, wherein one or more of the stationary blade and the moveable blade define a plurality of teeth along their cutting edges.

32) The nose hair trimming arrangement as claimed in claim 8, wherein at least one of the blades comprises a plate defining a pair of opposed major faces and a pair of opposed edges.

33) The nose hair trimming arrangement as claimed in claim 13, wherein the stationary blade comprises a plate defining a pair of opposed major faces and a pair of opposed edges.

34) The nose hair trimming arrangement as claimed in claim 13, wherein the movable blade comprises a plate defining a pair of opposed major faces and a pair of opposed edges.

35) The nose hair trimming arrangement as claimed in claim 13, wherein the stationary blade and the moveable blade each include cutting edges defining a plurality of teeth disposed along opposed sides.

36) The nose hair trimming arrangement as claimed in claim 35, wherein linear reciprocating movement of the plurality of teeth of the stationary blade and the moveable blade relative to each other defines the plurality of cutting zones.

37) The nose hair trimming arrangement as claimed in claim 13, wherein the stationary blade and the moveable blade abut each other.

38) The nose hair trimming arrangement as claimed in claim 37, wherein the stationary blade and the moveable blade abut each other and move relative to each other to define a pair of cutting zones along opposite sides of the adjacent stationary blade and the moveable blade.

39) The nose hair trimming arrangement as claimed in claim 31, wherein one or more selected from the size or pitch of the teeth on one side of one or more selected from the stationary blade and the moveable blade varies from that on the opposed side.

40) The nose hair trimming arrangement as claimed in claim 31, wherein one or more selected from the size or pitch of the teeth on one of the opposed edge of the stationary blade is similar to that of the adjacent moveable blade's teeth.

41) The nose hair trimming arrangement as claimed in claim 13, wherein the stationary blade and the moveable blade are at least partially received within and extend from the insertion formation.

42) The nose hair trimming arrangement as claimed in claim 8, wherein the cutting edge(s) of at least one of the blades are rounded to prevent injury to a user.

43) The nose hair trimming arrangement as claimed in claim 42, wherein the cutting edge(s) of the stationary blade are rounded to prevent injury to a user.

44) The nose hair trimming arrangement as claimed in claim 13, wherein at least one or more of the stationary blade and the moveable blade are rectangular in shape.

45) The nose hair trimming arrangement as claimed in claim 44, wherein the widths of the stationary blade and the moveable blade are substantially the same.

46) The nose hair trimming arrangement as claimed in claim 44, wherein the width of one of the stationary blade and the moveable blade is larger than the other.

47) The nose hair trimming arrangement as claimed in claim 44, wherein the width of the stationary blade is larger than the moveable blade.

48) The nose hair trimming arrangement as claimed in claim 8, further comprising a drive mechanism coupled to the cutting mechanism for driving movement of the moveable blade.

49) The nose hair trimming arrangement as claimed in claim 48, wherein the drive mechanism includes a mechanical linkage for translating rotational motion to linear motion.

50) The nose hair trimming arrangement as claimed in claim 48, wherein the drive mechanism is a reciprocating drive mechanism.

51) The nose hair trimming arrangement as claimed in claim 50, wherein the reciprocating drive mechanism includes a rotating member.

52) The nose hair trimming arrangement as claimed in claim 51, wherein the rotating member is coupleable to an electric motor.

53) The nose hair trimming arrangement as claimed in claim 50, wherein the reciprocating drive mechanism is for coupling to a rotating member having a pin extending therefrom, and comprises
a) a pivot member configured and adapted to pivot about a pivot axis; said pivot member coupleable to at least one movable blade;
b) wherein said pivot member includes a receiving formation for receiving the pin in a sliding fashion; and
c) wherein the operational rotation of the pin on the rotating member causes the pin to move within the receiving formation, while causing the pivot member to pivot about the pivot axis in a reciprocating manner; thereby to move the movable blade in a linear reciprocating fashion.

54) The nose hair trimming arrangement as claimed in claim 50, wherein the reciprocating drive mechanism comprises
a) a rotating member; and
b) a pin extending from the rotating member;
c) a pivot member configured and adapted to pivot about a pivot axis; said pivot member coupled to at least one movable blade;
d) wherein said pivot member includes a receiving formation for receiving the pin in a sliding fashion; and
e) wherein the operational rotation of the pin on the rotating member causes the pin to move within the receiving formation, while causing the pivot member to pivot about the pivot axis in a reciprocating manner; thereby to move the movable blade in a linear reciprocating fashion.

55) The nose hair trimming arrangement as claimed in claim 53 wherein the receiving formation is one selected from a recess or aperture.

56) The nose hair trimming arrangement as claimed in claim 8, further including an electric motor.

57) A nose hair trimming attachment adapted for being coupled to a driver mechanism, said nose hair trimming attachment comprising a nose hair trimming arrangement as claimed in claim 8.

58) A nose hair trimming attachment as claimed in claim 57, further comprising a coupling mechanism for coupling the nose hair trimming attachment to a driver mechanism.

59) A nose hair trimmer comprising a nose hair trimming arrangement as claimed in claim 8.

60) A nose hair trimmer as claimed in claim 59, further comprising a handle.

61) A nose hair trimmer as claimed in claim 59, further comprising a power coupling arrangement for coupling the nose hair trimmer to a power source.

62) A nose hair trimmer as claimed in claim 61, wherein the power source is one selected from a battery and mains power.

63) A nose hair trimmer as claimed in claim 59, further comprising an electric motor for moving the movable blade.

64) A blade arrangement for a hair trimmer, said blade arrangement comprising
a) at least one stationary blade for being secured to a housing in a stationary manner,
i) said stationary blade having two opposed major faces and at least two opposed edges, and
ii) and wherein said stationary blade further includes a pair of toothed cutting regions along its two opposed edges; wherein said toothed cutting regions defines a plurality of teeth;
b) at least one movable blade,
i) said movable blade having two opposed major faces and at least two opposed edges, and
ii) wherein said movable blade further includes a pair of toothed cutting regions along its two opposed edges; and
iii) wherein said toothed cutting regions defines a plurality of teeth;
c) wherein said stationary blade and said movable blade are adapted and configured for moveable engagement with each other each other along at least part of each of one of their major faces, so that their toothed cutting regions are disposed at least partially adjacent each other;
d) and wherein the relative movement between the stationary blade and movable blade at their adjacent toothed cutting regions defines a pair of cutting zones.

65) A blade arrangement as claimed in claim 64, wherein the stationary blade and movable blade are adapted and configured for being moved in a linear reciprocating manner relative to each other.

66) A blade arrangement as claimed in claim 65, wherein the stationary blade and movable blade have complementary engagement formations adapted for movable engagement with each other.

67) A blade arrangement as claimed in claim 66, wherein the complementary engagement formations define a track formation and a track follower formation.

68) A blade arrangement as claimed in claim 66, wherein the complementary engagement formations are a channel and ridge formation.

69) A blade arrangement as claimed in claim 64, wherein one selected from the pitch and size of the teeth on each side of the stationary blade is the same as that of the adjacent teeth on the movable blade.

70) A blade arrangement as claimed in claim 64, wherein the one selected from the pitch and size of the teeth on one edge of one or both of the stationary blade and the movable blade are different from that of the opposed edge.

71) A blade arrangement as claimed in claim 64, wherein the thickness of the blade at one edge of one or both selected from the stationary blade and movable blade is reduced in comparison to the thickness at the opposed edge.

72) A blade arrangement as claimed in claim 64, wherein the stationary blade and movable blade have similar widths.

73) A blade arrangement as claimed in claim 64, wherein the stationary blade is wider than the movable blade.

74) A blade arrangement as claimed in claim 64, wherein the stationary blade is slightly wider than the movable blade in order to avoid having the moving blade making contact in operation with the skin of a user.

75) A blade arrangement as claimed in claim 64, wherein the stationary blade and movable blade are rectangularly shaped.

76) A blade arrangement as claimed in claim 64, wherein the toothed edge on one major face of one or more selected from the stationary blade and the movable blade, is out of plane with the rest of the major face.

77) A blade arrangement as claimed in claim 76, wherein the toothed edge on one major face of one or more selected from the stationary blade and the movable blade, is out of plane with the rest of the major face to form a first and second surface.

78) A blade arrangement as claimed in claim 64, wherein the toothed edge on both major faces of one or more selected from the stationary blade and the movable blade is out of plane with the rest of the major face.

79) A blade arrangement as claimed in claim 78, wherein both of the toothed edges on both major faces of one or more selected from the stationary blade and the movable blade are out of plane with the rest of the major faces.

80) A blade arrangement as claimed in claim 64, wherein both of the toothed edges on both major faces of one or more selected from the stationary blade and the movable blade are out of plane with the rest of the major to define at least a first and second surface on each major face.

81) A hair trimmer mechanism including a blade arrangement as claimed in claim 64.

82) A hair trimmer mechanism including a blade arrangement as claimed in claim 64.

83) A hair trimmer including a blade arrangement as claimed in claim 64.

84) A removable hair trimmer attachment including a blade arrangement as claimed in claim 64.

85) A method of manufacture of a blade for a hair trimmer, comprising the steps, of
a) providing a planar plate of sheet material having two opposed major faces and two opposed edges;
b) deforming at least a portion of at least one or more of the opposed edges on at least one major face of the plate; and
c) grinding at one or more of the opposed edges of the plate to a thinner thickness.

86) A method of manufacture as claimed in claim 85, wherein the step of deforming, deforms at least a portion of one opposed edge on at least one major face of the plate to reduce its thickness.

87) A method of manufacture as claimed in claim 86, wherein the step of deforming is carried out by a press.

88) A method of manufacture as claimed in claim 86, wherein the step of deforming results in a portion of the surface of that major face of the plate at that edge of the plate is out of plane with another part of that major surface.

89) A method of manufacture as claimed in claim 85, wherein the step of deforming deforms both major faces of the plate so that at least a portion of at least one opposed edge on both major faces results in a portion of the surface of that major face of the plate at that edge of the plate is out of plane with another part of that major surface.

90) A method of manufacture as claimed in claim 85, wherein the step of deforming further comprises cutting out the shape of teeth along one or both of the opposed edges.

91) A method of manufacture as claimed in claim 85, wherein the step of deforming is carried out over two steps comprising the steps of:
a) deforming the plate to reduce the thickness of the plate at an edge by applying a force to the edge at a major face while supporting the opposed major face,
b) deforming both major faces of the plate by bending it so that at least a portion of at least one opposed edge on both major faces results in a portion of the surface of that major face of the plate at that edge of the plate is out of plane with another part of that major surface.

92) A method of manufacture as claimed in claim 85, wherein the step(s) of deforming is carried on to deform the full length of at least one opposed edge.

93) A method of manufacture as claimed in claim 85, wherein the step(s) of deforming is carried on to deform the full length of both opposed edges.

94) A method of manufacture as claimed in claim 85, wherein the step of deforming is carried out by applying force to at least a portion of one of the opposed edges.

95) A method of manufacture as claimed in claim 85, wherein the step of deforming is carried out by applying force to at least a portion of both of the opposed edges.

96) A method of manufacture as claimed in claim 86, wherein the step of deforming to thin the thickness of the plate is carried out by application of a force to one major face, and the step of grinding is applied to the opposed major face.

97) A method of manufacture as claimed in claim 96, wherein the step of grinding is carried out over an entire face of the plate.

98) A method of manufacture as claimed in claim 86, wherein the step(s) of deforming at least one or more of the opposed edges to thin the thickness of the plate is carried out by applying a force from the side of one major face while supporting the opposed major face, and the step of grinding is carried out over at least part of an opposed major face of the plate.

99) A method of manufacture as claimed in claim 89, wherein the step of deforming is carried out by application of a force to one major face to deform both major faces at least one of the opposed edges, and the step of grinding is applied to the opposed major face.

100) A method of manufacture as claimed in claim 89, wherein the step of deforming both major faces of the plates is carried out by applying a force to a part of one major face, while allowing the adjacent part of the opposed major face to remain unsupported.

101) A method of manufacture as claimed in claim 89, wherein the step of deforming both major faces of the plate so that at least a portion of at least one opposed edge on both major faces results in a portion of the surface of that major face of the plate at that edge of the plate is out of plane with another part of that major surface is carried out by application of a force to one major face to deform both major faces at least one or more of the opposed edges, and the step of grinding is applied to the opposed major face.

102) A method of manufacture as claimed in claim 99, wherein the step of deforming is carried out by application of a force to one major face to deform both major faces at both of the opposed edges.

103) A method of manufacture as claimed in claim 85, wherein the step of grinding is carried out to grind the two opposed edges to a co-planar configuration.

104) A method of manufacture as claimed in claim 85, wherein the step of grinding is carried out to grind the two opposed edges to a co-planar configuration simultaneously.

105) A method of manufacture as claimed in claim 85, wherein the step of deforming comprises applying a force to the full edge of the plate.

106) A method of manufacture as claimed in claim 85, wherein the plate is metallic.

107) A method of manufacture as claimed in claim 85, wherein the method includes the step of machining at least one edge of the plate to reduce the thickness of at least a portion of the edge.

108) A method of manufacture as claimed in claim 83, wherein the method includes the step of machining at least one deformed edge of the plate to reduce the thickness of at least a portion of the edge.

109) A method of manufacture as claimed in claim 85, wherein the deformation of at least a portion of at least one opposed edge to thin the thickness of the plate is carried out by a hydraulic press.

110) A method of manufacture as claimed in claim 85, wherein the deformation of at least a portion of at least one opposed edge to thin the thickness of the plate is carried out by transfer of kinetic energy.

111) A method of manufacture as claimed in claim 85, wherein the deformation of at least a portion of at least one opposed edge to thin the thickness of the plate is carried out by transfer of kinetic energy in an impact from an impaction member.

112) A method of manufacture as claimed in claim 85, wherein the step of deforming the plate includes the process of cutting teeth shapes out of the plate.

113) A method of manufacture as claimed in claim 85, wherein the teeth shapes along one edges are of a different size and/or pitch to those at the opposed side.

114) A method of manufacture of a blade for a hair trimmer, comprising the steps of
a) providing a planar plate of sheet material having two opposed major faces and two opposed edges;
b) machining at least a portion of at least one opposed edge on a major face to thin the thickness of the plate; and
c) grinding at least the formed edge of the plate to a thinner thickness.

115) A method of manufacture as claimed in claim 114, wherein the step of machining results in a portion of the surface of that major face of the plate at that edge of the plate being out of plane with another part of that major surface.

116) A method of manufacture as claimed in claim 114, wherein the step of machining results in the major surface of the plate at that edge being out of plane with another part of that major surface.

117) A method of manufacture as claimed in claim 114, wherein the step of grinding is carried out on a major face of the plate on an opposed side of the plate to where the machining step was carried out.

118) A method of manufacture as claimed in claim 114, wherein the method includes the step of deforming at least a portion of at least one opposed edge on at least one major face.

119) A method of manufacture as claimed in claim 114, wherein the method includes the step of deforming at least a portion of at least one opposed edge on at least one major face to thin the thickness of the plate.

120) A method of manufacture as claimed in claim 119, wherein the step of deforming at least a portion of at least one opposed edge on a major face results in a portion of the surface of that major face of the plate at that edge of the plate being out of plane with another part of that major surface.

121) A method of manufacture as claimed in claim 118, wherein the step of deforming is carried on to deform at least a portion of at least one opposed edge on both major faces results in the deformation of both major faces of the plate so that at least a portion of at least one opposed edge on both major faces results in a portion of the surface of the major faces of the plate at that edge of the plate being out of plane with another part of the major faces.

122) A method of manufacture as claimed in claim 118, wherein the step of deforming is carried on to deform the full length of at least one opposed edge.

123) A method of manufacture as claimed in claim 118, wherein the step of deforming is carried on to deform the full length of both opposed edges.

124) A method of manufacture as claimed in claim 118, wherein the step of deforming is carried out by application of a force to one major face, and the step of grinding is applied to the opposed major face.

125) A method of manufacture as claimed in claim 114, wherein the step of grinding is carried out over an entire face of the plate.

126) A method of manufacture as claimed in claim 118, wherein the step of deforming one of the opposed edges is carried out by applying a pressing action from the side of one major face, and the step of grinding is carried out over at least part of an opposed major face of the plate.

127) A method of manufacture as claimed in claim 121, wherein the step of deforming is carried out by application of a force to at least a portion of one major face while allowing the adjacent portion of the opposed major face to remain unsupported, thereby to deform both major faces.

128) A method of manufacture as claimed in claim 119, wherein the step of deforming is carried out by application of a force to at least a portion of one major face while supporting the adjacent portion of the opposed major face, thereby to reduce the thickness of the plate at the said portion of the major face.

129) A method of manufacture as claimed in claim 127, wherein the step of deforming deforms both major faces at least one of the opposed edges.

130) A method of manufacture as claimed in claim 118, wherein the step of deforming deforms both of the opposed edges.

131) A method of manufacture as claimed in claim 114, wherein the step of grinding is carried out to grind the two opposed edges to a co-planar configuration.

132) A method of manufacture as claimed in claim 131, wherein the step of grinding is carried out to grind the two opposed edges to a co-planar configuration simultaneously.

133) A method of manufacture as claimed in claim 118, wherein the step of deforming includes applying a force to the full edge of the plate.

134) A method of manufacture as claimed in claim 118, wherein the step of deforming flattens both opposed edges of the plate.

135) A method of manufacture as claimed in claim 114, wherein the plate is metallic.

136) A method of manufacture as claimed in claim 118, wherein the deformation of at least a portion of at least one opposed edge to thin the thickness of the plate is carried out by a hydraulic press.

137) A method of manufacture as claimed in claim 119, wherein the deformation of at least a portion of at least one opposed edge to thin the thickness of the plate is carried out by transfer of kinetic energy.
